(19) United States
(12) Patent Application Publication
(10) Pub. No.: US 2002/0189978 A1
(43) Pub. Date: Dec. 19, 2002

(54) Method and apparatus for removing cut trim and dust

(75) Inventor: Ross A. Freeman, Somersworth, NH (US)

Correspondence Address: SIMPSON & SIMPSON, PLLC, 5555 MAIN STREET, WILLIAMSVILLE, NY, 14221-5406, US

(73) Assignee: Moore North America, Inc., Grand Island, NY

(21) Appl. No.: 09/880,537

(22) Filed: Jun. 13, 2001

(51) Int. Cl. B07B 1/10

(52) U.S. Cl. 209/307; 209/643

(57) ABSTRACT

An apparatus for removing cut trim and dust from a paper handling machine, comprising an inlet port for carrying the cut trim and dust from the paper handling machine, a perforated conveyor located in a first chamber of the apparatus and operatively arranged to transport the cut trim from the inlet port to a waste container, and to transport the dust through the perforations to an ancillary chamber, and, means for creating a vacuum within the inlet port and the first and ancillary chambers to cause the dust to be transported from the inlet port, through the perforated conveyor in the first chamber, to the ancillary chamber. The method includes steps to separate cut trim from dust under vacuum.

### FIELD OF THE INVENTION

The present invention relates generally to paper handling systems, more particularly to cut trim removal systems, and, even more particularly, to a method and apparatus for removing cut trim and dust.

### BACKGROUND OF THE INVENTION

Many paper handling systems produce waste paper trim and dust as part of their processes. For example, high speed computer printers, paper cutters and form bursters have tractor feeders that engage the tractor drive strips at the edges of continuous webs of computer paper. These drive strips are often trimmed away as part of the process which produces strips or pieces of paper and significant amounts of paper dust.

Several systems have been developed to deal with waste trim that remains in the form of a continuous strips such as an automatic trim rewinder disclosed in U.S. Pat. No. 4,572,496 entitled “Trim Rewinder With Automatic Stop” and U.S. Pat. No. 5,322,232 entitled “Portable Paper Trim Removal System With Trim Rewinder and Dust Vacuum”. While these systems are effective in dealing with continuous waste strips which are typically wound in the form of balls or rolls, neither are designed to deal with paper trim which is produced in the form of pieces.

Presently, cut paper trim produced by paper handling systems typically drops by gravity into a small bin under the process. Since many of today's paper handling systems operate at high speed, these small bins must be emptied often to prevent overflow. This is work-intensive and messy as some of the paper usually tends to float away during handling. The bins can also be quite heavy, creating a problem with lifting injuries. In many cases the processes must be shut down while the waste bins are emptied which reduces productivity.

The paper dust, produced as paper is cut, builds up on the equipment and causes failures and fire hazards. It also gets into the air and can be hazardous if inhaled by the operators and other people in the room. This dust needs to be removed and disposed of along with the waste trim.

Thus, there is a need for a method and apparatus for efficiently removing both cut paper trim and associated dust.

### SUMMARY OF THE INVENTION

The present invention generally comprises an apparatus for removing cut trim and dust from a paper handling machine, comprising an inlet port for carrying the cut trim and dust from the paper handling machine, a perforated conveyor located in a first chamber of the apparatus and operatively arranged to transport the cut trim from the inlet port to a waste container, and to transport the dust through the perforations to an ancillary chamber, and, means for creating a vacuum within the inlet port and the first and ancillary chambers to cause the dust to be transported from the inlet port, through the perforated conveyor in the first chamber, to the ancillary chamber. The method includes steps to separate cut trim from dust under vacuum.

A primary object of the invention is to provide a more efficient method and apparatus for removing cut paper trim waste from post print processing equipment such as cutters and inserters and to deliver the cut trim and associated dust to a removable disposal bin and filter respectively.

A further object is to provide a method and apparatus for processing a wide variety of post print processing waste, and to separate cut trim from dust in the waste, for disposal.

These and other objects, features and advantages of the invention will become apparent upon a reading of the detailed description and appended claims in view of the several drawing figures.

### BRIEF DESCRIPTON OF THE DRAWINGS

FIG. 1 is a perspective view of the apparatus of the invention attached to a paper handling machine and trim bin;

FIG. 2 is a perspective view of the apparatus of the invention;

FIG. 3 is a side view of the apparatus of the invention shown in FIG. 2;

FIG. 4 is a side view similar to that of FIG. 3, but with sections of the apparatus cut away to reveal internal machine components;

FIG. 5 is a view similar to that of FIG. 4, but annotated to illustrate air and trim flow and separation of air and trim through the machine;

FIG. 6 is a fragmentary view of the apparatus of the invention, taken generally along line A-A of FIG. 4;

FIG. 7 is a view similar to that of FIG. 6, except with sections of the apparatus cut away to reveal internal machine components;

FIG. 8 is a fragmentary side view of the apparatus of the invention, taken generally along line C-C of FIG. 4;

FIG. 9 is a fragmentary top view of the perforated conveyor belt of the apparatus of the invention;

FIG. 10 is an enlarged, fragmentary view of the internal spring loaded flapper plate of the apparatus of the invention, taken generally along line D-D of FIG. 6.

### DETAILED DESCRIPTION OF THE PREFERRED EMBODIMENT

At the outset, it should be clearly understood that the drawings are to be read together with the specification, and are to be considered a portion of the entire “written description” of this invention, as required by 35 U.S.C. §112. Also, identical reference numerals on different figures refer to identical elements of the invention.

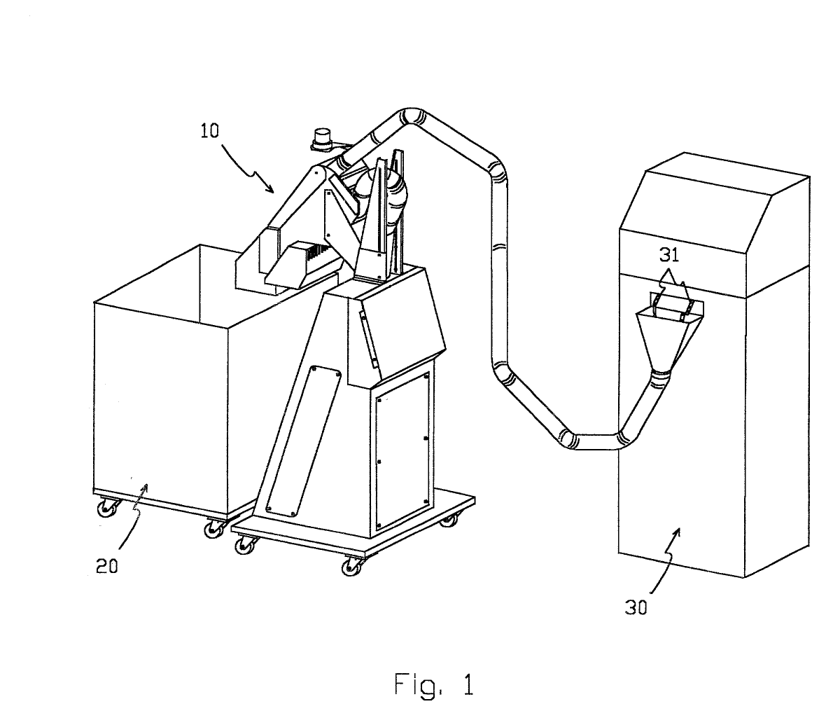

Adverting now to the drawings, FIG. 1 illustrates trim removal apparatus 10 in operation. The apparatus functions to transport cut trim waste 31 and dust (not shown in this drawing) from paper handling machine 30, and conveys the waste cut trim to waste receptacle 20. The dust is captured within an air filter in the apparatus, as will be described infra.

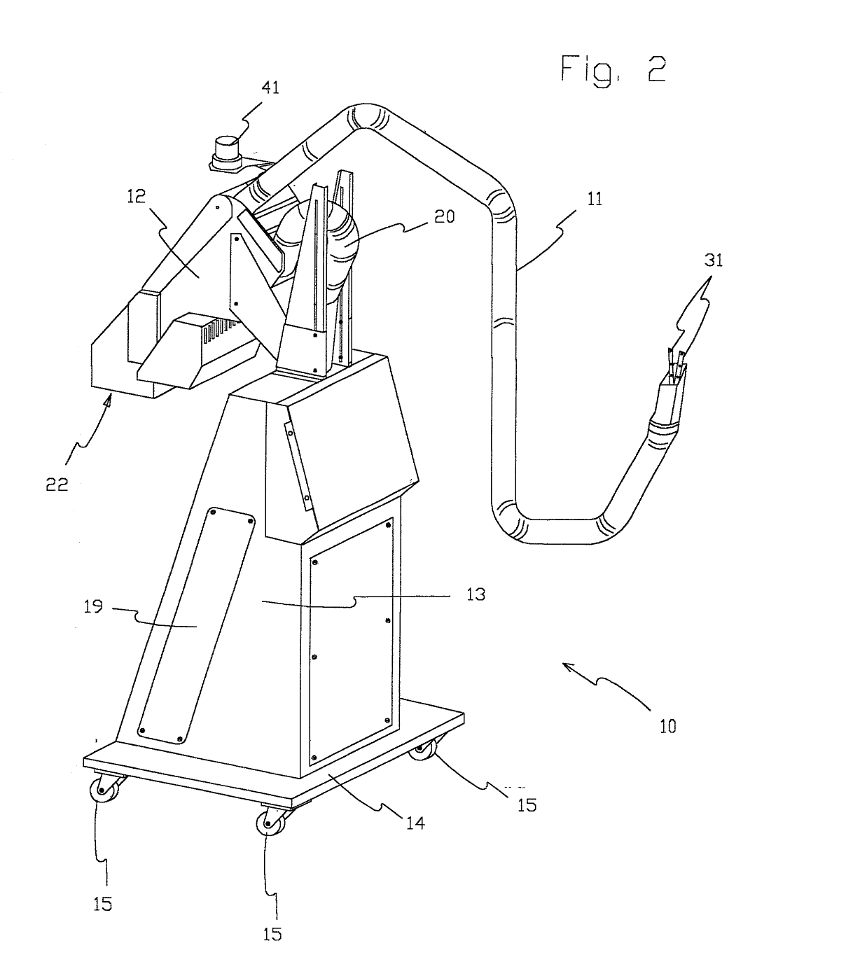

Apparatus 10 is shown in more detail in perspective view in FIG. 2. The apparatus is seen to include inlet port 11 arranged to receive cut trim 31 and dust 32 (not shown) from paper handling machine 30. In a preferred embodiment, the inlet port is a hose.

Inlet port 11 transports the cut trim and dust to first chamber 12 where the cut trim is separated from the dust. The cut trim is ejected from the machine via exit port 16, while the dust proceeds via transport hose 20 to ancillary chamber 13. The dust is then trapped in a filter accessible via filter cover plate 19. In the preferred embodiment illustrated in FIG. 2, apparatus 10 is supported by base plate 14 atop casters 15, enabling the apparatus to be transported from place to place within a facility.

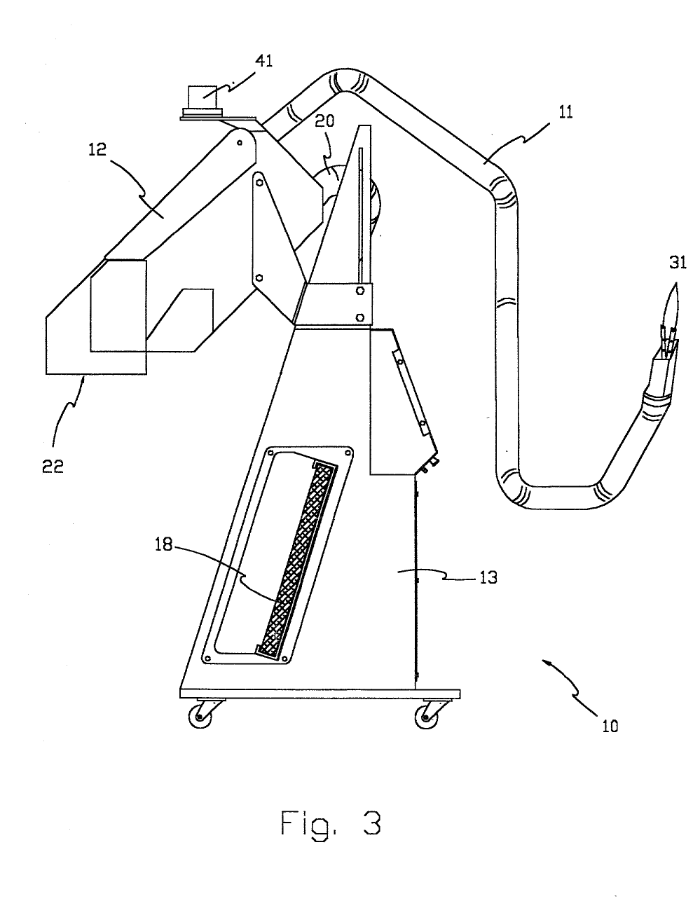

FIG. 3 is a side view of the apparatus shown in FIG. 2. In this view, air filter cover plate 19 has been removed to show air filter 18 in ancillary chamber 13. Apparatus 10 is also shown to include strobe light 41 which is activated when apparatus 10 is processing cut trim. This is a safety feature to alert workers that the apparatus is operating. The strobe light also functions to alert of fault conditions including cover open, vacuum low and vacuum high.

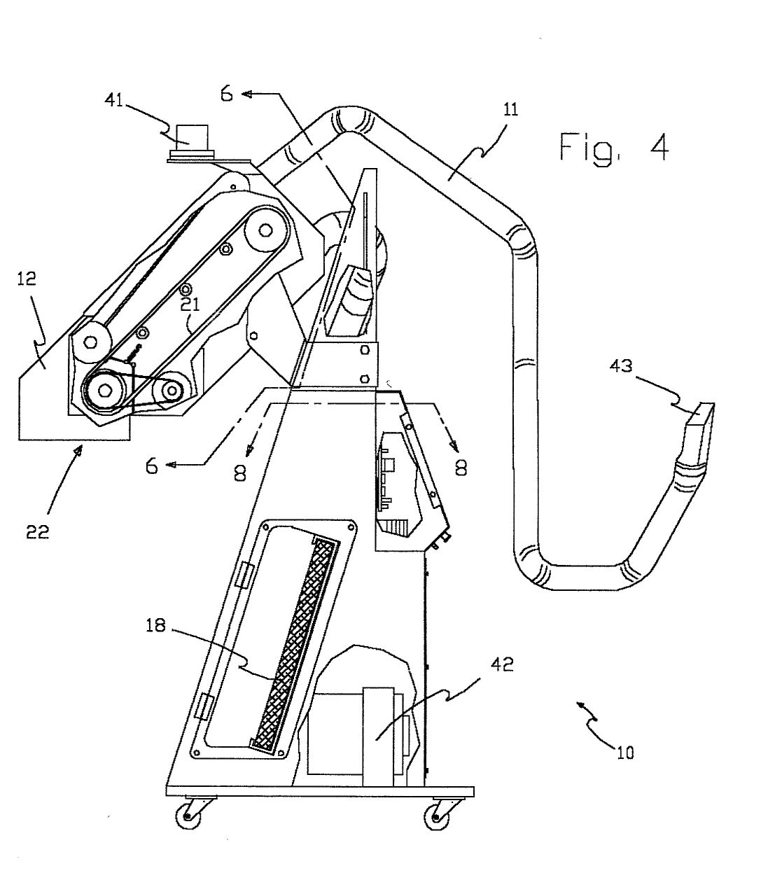

The apparatus is shown again in FIG. 4, in a view similar to that of FIG. 4 except with a part of the first chamber broken away to reveal conveyor 21, air filter 18, blower motor 42, and associated components. As will be discussed infra, the conveyor functions to convey the cut trim from the inlet port to the exit port, and to separate cut trim from dust.

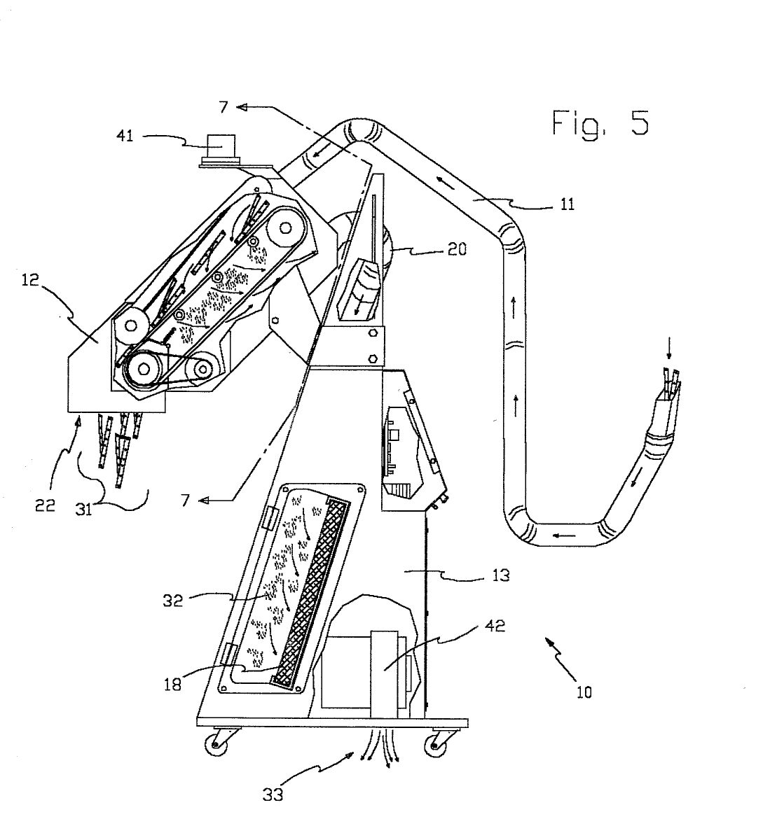

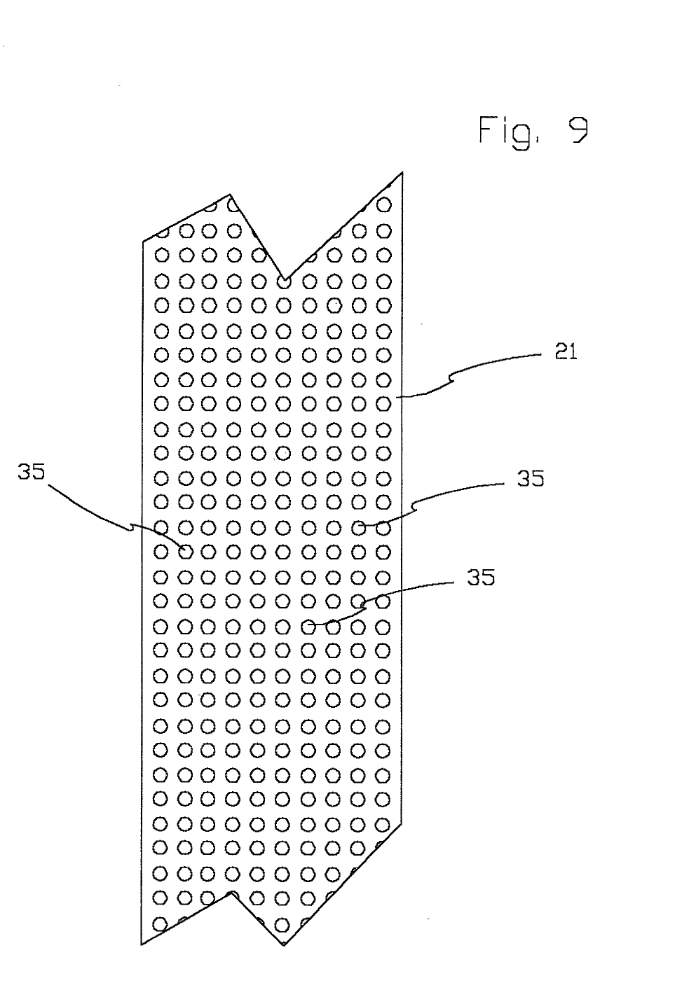

The flow of cut trim and dust is illustrated most clearly in FIG. 5. Cut trim 31 enters inlet hose 11 at inlet 43 and proceeds through the hose to first chamber 12. Conveyor 21 is perforated as shown in FIG. 9. FIG. 9 illustrates that conveyor belt 21 includes a plurality of perforations 35. The perforations enable dust to fall through conveyor belt 21 as best illustrated in FIG. 5 while cut trim 31 proceeds along the conveyor belt, exiting the apparatus at exit port 22. The dust continues into intermediate passageway 20 into ancillary chamber 13 where dust particles 32 are trapped by air filter 18. In a preferred embodiment, the filter is chosen to filter particles down to approximately 5 microns in diameter, and the filtered air is then allowed to return to the room. The entire system operates under vacuum created by blower motor 42 which sucks air into inlet hose 11 and exits exhaust air through exit port 33.

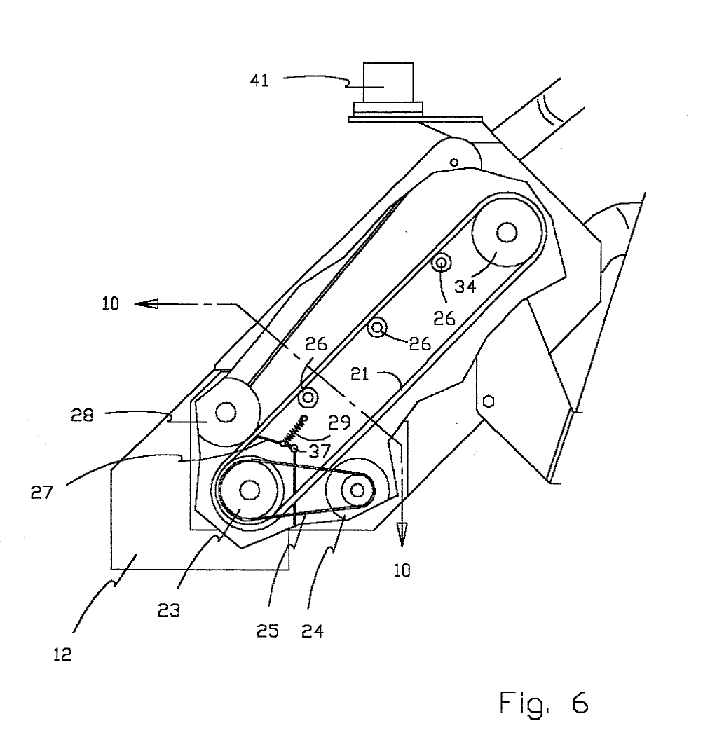

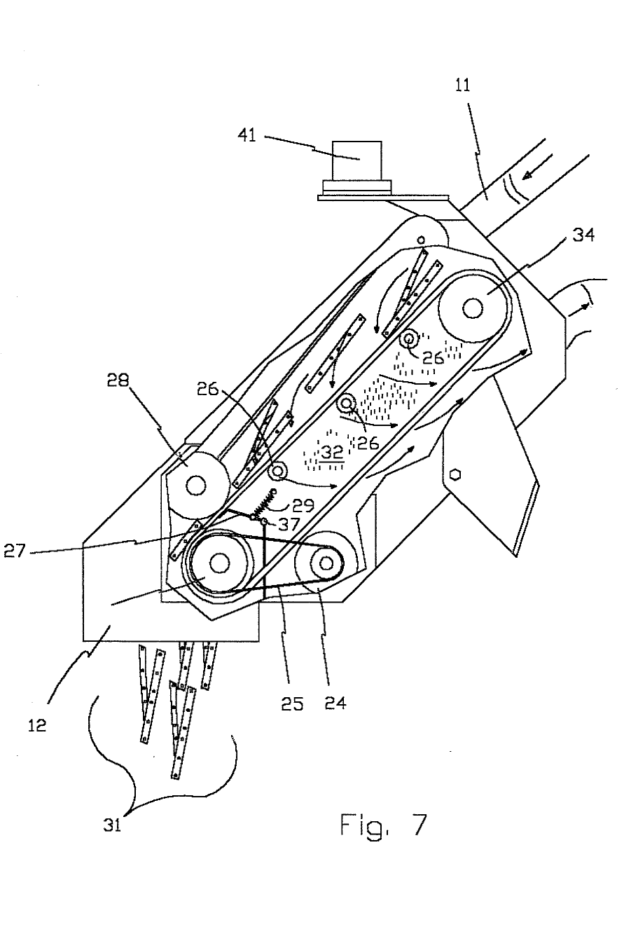

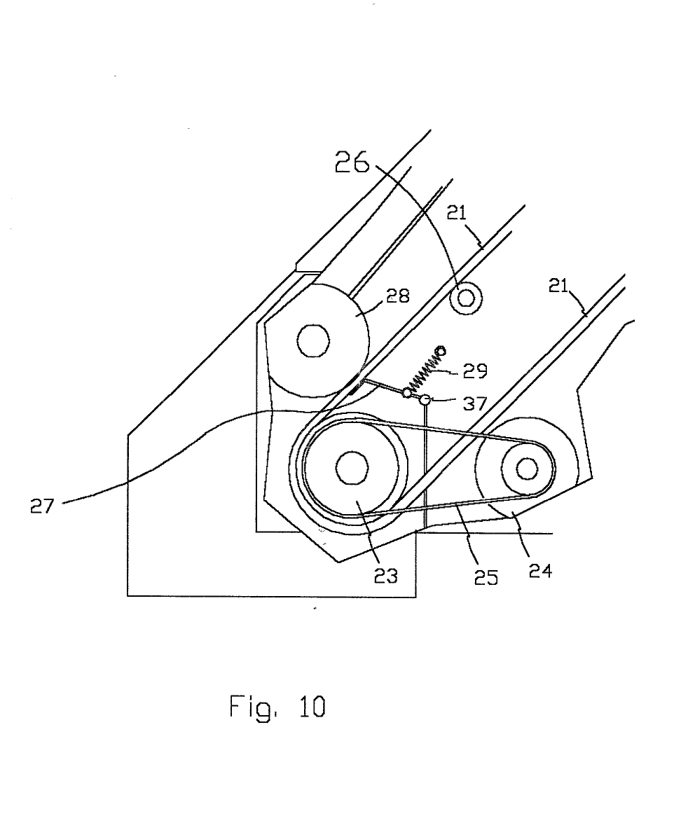

The components within the first chamber are shown most clearly in enlarged view in FIG. 6. Motor 24 drives pulley 23 of the conveyor via drive conveyor belt 25. Pulley 23 intern drives conveyor belt 21 about pulley 34. In a preferred embodiment, the speed of the drive conveyor pulley can be adjusted to result in a maximum conveyor belt speed of approximately 600 fpm. This permits the apparatus to service host/target machines which typically run at speeds of 250-300 fpm. Conveyor belt 21 is supported and rides atop guide 26. Guide 26 and spring-loaded guide 27 function cooperatively to bias belt 21 upwardly toward roller 28. (Spring-load guide 27 is biased in a clockwise direction about pivot 37 by spring 29 has more clearly shown in FIG. 10.) The guides function to maintain a seal, ensuring a vacuum to force dust particles through the perforations of belt 21. If the flow of cut trim 31 and dust particles 32 is shown in more detail in FIG. 7. This view clearly shows how the dust particles 32 are transported under vacuum through the perforations in belt 21.

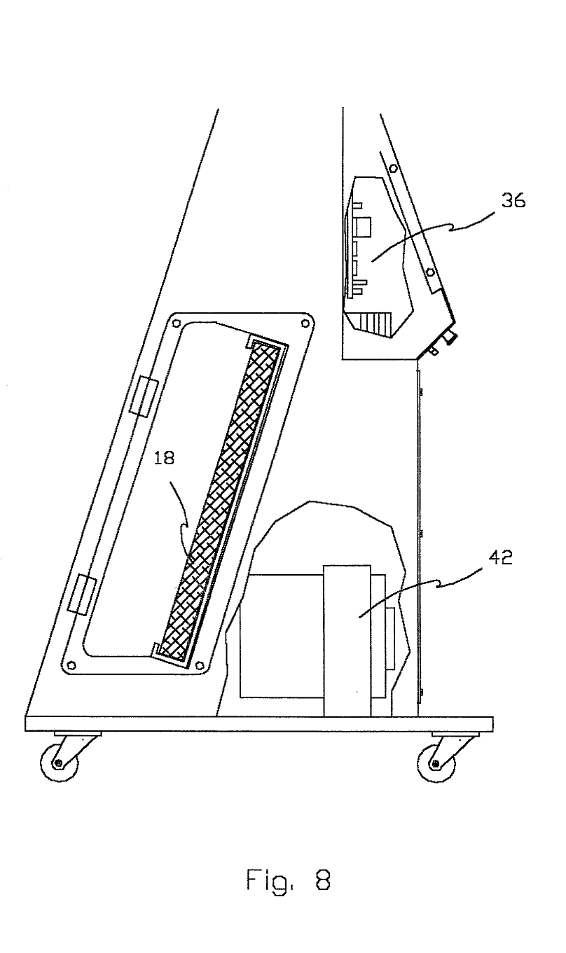

Air filter 18, blower motor 42, and electronic control board 36 are shown in a cutaway view in FIG. 8. These components are all mounted within ancillary chamber 13 of apparatus 10. The blower functions to create a vacuum in the first chamber and inlet hose, sucking air and dust particles through the perforations of belt 21. In a preferred embodiment, a Windjammer® brand blower model no. 119104 M (High Flow), available from Ametek, was used to create a vacuum of approximately 57 in. H₂O. These particular motor, rated 800 Watts at 120 VAC, was run satisfactorily at a flow rate of approximately 109 CFM.

The apparatus as described above is capable of accommodating a large variety of machine generated trim waste. The margin trim can be either cut or burst at form length, or chopped into shorter pieces. The device can handle margin trim from approximately ½ to 1 inch and up to 14 inches long. The device can also handle a cross-perforation cut maximum size of 0.2 inches wide by 19 ½ inches long or equivalent when cutting 2-up. Finally, the device can handle paper weights in the range from 10 lb. bond to 100 lb. tag, with thickness equivalent from approximately 0.002 to 0.008 inches. It should be appreciated, though, that for weights above 32 lb. bond trim, the width may be limited to ½ inch.

In a preferred embodiment, the unit is programmed to turn on when the target machine (the waste generator) begins to run and will stop 15 seconds after the target stops. This provides continuous operation of the trim removal device for momentary system pauses when offloading or offsetting. Also in a preferred embodiment, with the host equipment running at 250 fpm, the time between bin changes by the operator will be no less than 2 hours with an 18 cubic foot capacity bin. The device can run while the trim waste is removed for disposal eliminating the need to shut down the host equipment during waste removal.

Thus, it is seen that the objects of the invention are efficiently obtained, although modifications and changes will be readily apparent to those having ordinary skill in the art, and those changes are intended to be within the scope of the claims.

What is claimed is:

1. An apparatus for removing cut trim and dust, comprising:
an inlet port for carrying said cut trim and dust from a paper handling machine;
a perforated conveyor located in a first chamber and operatively arranged to transport said cut trim from said inlet port to a waste container, and to transport said dust through said perforations to an ancillary chamber; and,
means for creating a vacuum within said inlet port and said first and ancillary chambers to cause said dust to be transported from said inlet port, through said perforated conveyor in said first chamber, to said ancillary chamber.

2. The apparatus recited in claim 1, further comprising an exit roller and spring-loaded flapper plate juxtaposed on opposite sides of said perforated conveyor, and in substantial contact therewith, to create and maintain said vacuum.

3. The apparatus recited in claim 1, further comprising a filter in said ancillary chamber operatively arranged to catch and trap said dust.

4. The apparatus recited in claim 1 wherein said means for creating a vacuum comprises a motor-driven blower.

5. The apparatus recited in claim 3, wherein said filter functions to filter said dust inclusive of particles as small as approximately five (5) microns in diameter.

6. The apparatus recited in claim 5, further comprising means for venting filtered air to return to a room where said apparatus is located.

7. The apparatus recited in claim 1 wherein said conveyor is motor-driven.

8. The apparatus recited in claim 7 further comprising means for adjusting speed of said conveyor to a maximum speed of approximately 600 feet/minute.

9. A method of removing cut trim and dust from a paper handling machine, comprising:
receiving said cut trim and dust via an inlet port under vacuum, into a first chamber;
transporting said cut trim on a perforated conveyor within said first chamber, to an exit port; and,
separating said dust and said trim at said conveyor by vacuum transport of said dust through the perforations of said conveyor into an ancillary chamber.

10. The method of removing cut trim and dust recited in claim 9, further comprising the step of passing said dust through a filter to trap said dust.
